(19) United States
(12) Patent Application Publication
(10) Pub. No.: US 2009/0148751 A1
(43) Pub. Date: Jun. 11, 2009

(54) MEMBRANE ELECTRODE ASSEMBLY FOR FUEL CELL, AND METHOD OF MANUFACTURING THE SAME

(75) Inventors: Yeong-Suk Choi, Suwon-si (KR); Tae Kyoung Kim, Seoul (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/175,198

(22) Filed: Jul. 17, 2008

(30) Foreign Application Priority Data
Dec. 7, 2007 (KR) 2007-126907

(51) Int. Cl. H01M 4/00; B05D 5/12

(52) U.S. Cl. 429/40; 427/115

(57) ABSTRACT

A membrane electrode assembly (MEA) for a fuel cell, and a method of making the same, the MEA including: an electrolyte membrane; binder layers including a sulfonated polysulfone-clay nanocomposite, and a tackifier, disposed on opposing sides of the membrane; and electrodes including electrode catalytic layers, disposed on the binder layers.

### CROSS-REFERENCE TO RELATED APPLICATION

This application claims the benefit of Korean Application No. 2007-126907, filed Dec. 7, 2007, in the Korean Intellectual Property Office, the disclosure of which is incorporated herein by reference.

### BACKGROUND OF THE INVENTION

1. Field of the Invention

Aspects of the present invention relate to a membrane electrode assembly (MEA) for a fuel cell, and a method of manufacturing the same.

2. Description of the Related Art

Polymer electrolyte-based fuel cells can be direct fuel that directly obtain protons from a hydrogen rich fuel, such as methanol, or can be conventional polymer electrolyte-based fuel cells that use hydrogen gas as fuel. Direct fuel cells have a lower power output, as compared to conventional polymer electrolyte-based fuel cells, but directly use a liquid fuel, without the need for a reformer to convert the fuel into hydrogen. Direct fuel cells have a high energy density, provide a longer battery life per charge, and therefore, are well suited for portable devices.

In a direct fuel cell, a fuel, such as a methanol solution, reacts in a catalytic layer of an anode to produce protons, electrons, and carbon dioxide. The electrons are conducted to an electrode material, the protons pass through the polymer electrolyte, and the carbon dioxide is discharged from the electrode material, to the outside of the system. Therefore, the permeability of the fuel and carbon dioxide discharge-ability are also important considerations.

Moreover, at the cathode of a direct methanol fuel cell, in addition to the same reaction occurring as in a conventional polymer electrolyte-based fuel cell, a fuel permeates the electrolyte membrane, and an oxidizing gas, such as oxygen in air, reacts in the catalytic layer of the cathode to produce carbon dioxide and water. Therefore, more water is produced as compared to a conventional polymer electrolyte-based fuel cell, requiring a more efficient way to release water.

As a conventional polymer electrolyte membrane, a perfluoro-based proton conductive polymer membrane, such as NAFION (Dupont Co.), is used. However, these perfluoro-based proton conductive polymer membranes have a high permeability to fuels such as methanol. When used in direct fuel cells, such a membrane reduces the cell power and/or energy efficiency thereof.

Several non-perfluoro-based proton conductive polymer membranes, such as a polymer electrolyte membrane with an anionic functional group integrated into a non-fluoro-based aromatic polymer, have been suggested. However, in order to obtain a high conductivity, these polymer electrolyte membranes increase the amount of a conductive ion group (an anionic group such as sulfonic acid) that is added thereto. This results in increased swelling of the membrane, due to the influx water or methanol, which can result in a large amount of fuel cross-over. In order to overcome these drawbacks, a less anionic group can be integrated to reduce the fuel cross-over. However, this decreases the ion conductivity and can result in a polymer electrolyte membrane that has low adhesion to catalyst ionomers, making the interactions between the electrodes insufficient. This can decrease ion conductivity in a membrane-electrode complex and degrad performance.

In order to overcome the problems described above, a method of interposing a material having an anionic group between the electrolyte and the electrode has been suggested (Japanese Patent Laid-open Publication No. 59-209278 and Japanese Patent Laid-Open Publication No. 4-132168). However, the methods described above require a large amount of time to adhere the electrode to the membrane, and the attachment between the electrode and the electrolyte is insufficient, thereby making it difficult to obtain a fuel cell having a high power output.

When forming a catalyst-coated membrane (CCM), according to the conventional art, a catalytic layer and an electrolyte membrane are adhered at a high temperature and high pressure (0.5 ton/cm2 or higher), in order to bind the catalyst particles of the catalytic layer to the electrolyte membrane. The high pressure is required because the catalyst particles of the catalytic layer do not exert any adhesive or attractive force on the electrolyte membrane. Therefore, the electrolyte membrane and the catalytic layer need to be compressed at a high pressure, so that the catalytic layer is transferred to the surface of the electrolyte.

In order to bind to the electrolyte membrane, the particle size of a PtRu anode catalyst, is larger than a Pt cathode catalyst, and thus, the volume of the anode catalyst is greater than the volume of the cathode catalyst, at equal weights, making the catalytic layer thicker. Accordingly, the compression levels within the catalytic layer vary, when pressure is applied to transfer the catalytic layer of a catalytic layer transfer film, to the electrolyte membrane. That is, a large amount of pressure is applied to the catalytic layer, in order to transfer the thicker catalytic layer, thereby lowering the porosity of the catalytic layer. Therefore, fuel transport to, and by-product removal from, the catalytic layer is impeded. Accordingly, a method of transferring the catalytic layer to the electrolyte membrane at a low pressure is needed.

Moreover, when a catalyst-coated membrane (CCM) is formed using a conventional decal transfer method, in which an electrode catalytic layer is transferred to a membrane, due to a high pressure applied during the process of transferring the catalytic layer-forming transfer film to the electrolyte membrane, the porosity of the electrode catalytic layer is decreased, thereby decreasing the power output of the cell. Thus, there is a need for further improvements.

### SUMMARY OF THE INVENTION

Aspects of the present invention provide a membrane electrode assembly (MEA) for a fuel cell, having an improved adhesion between a catalytic layer and an electrolyte membrane, while maintaining the porosity of the catalytic layer, and a method of manufacturing the same.

According to an aspect of the present invention, there is provided an MEA for a fuel cell, including: an electrolyte membrane; binder layers comprising a sulfonated polysulfone-clay nanocomposite and a tackifier, disposed on opposing sides of the electrolyte membrane; and electrodes comprising catalytic layers, disposed on the binder layers.

According to another aspect of the present invention, there is provided a method of fabricating an MEA, including: mixing a sulfonated polysulfone-clay nanocomposite, a tackifier, and a first solvent, to obtain a binder layer forming composition; coating the binder layer-forming composition on a first support membrane and then removing the solvent, to form a binder layer on the first support membrane; attaching the binder layer to a first surface of an electrolyte membrane and then removing the first support membrane from the binder layer; forming a catalytic layer on a second support membrane; and attaching the catalytic layer to the binder layer and then removing the second support membrane from the catalytic layer.

According to aspects of the present invention, the transfer pressure used in the CCM-forming process may be 0.001 to 0.3 ton/cm².

According to another embodiment of the present invention, there is provided a method of fabricating a membrane electrode, including: mixing sulfonated polysulfone-clay nanocomposite, a tackifier, and a first solvent, to obtain a binder layer-forming composition; coating binder layer-forming composition on a first support membrane and then removing the solvent to obtain a binder layer; attaching the binder layer to the electrolyte membrane and then removing the first support membrane from the binder layer; coating a catalytic layer-forming composition comprising a metal catalyst, an ionomer, and a second solvent on a gas diffusion layer, to form an electrode catalytic layer; and then attaching the electrode catalytic layer to the binder layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIGS. 1A through 1E illustrate a method of forming a membrane electrode assembly (MEA), according to an exemplary embodiment of the present invention;

FIGS. 2 and 3 are scanning electron micrographs (SEM) showing cross-sections of catalyst-coated membranes (CCM), according to an Example 1 and a Comparative Example 1; and

FIG. 4 is a graph showing cell voltages and power output density changes, with reference to current density, of fuel cells manufactured according to Example 1 and Comparative Examples 1-2.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures. As referred to herein, when a first element is said to be formed or disposed “on”, or adjacent to, a second element, the first element can directly contact the second element, or can be separated from the second element by one or more other elements can be located therebetween. In contrast, when an element is referred to as being formed or disposed “directly on” another element, there are no intervening elements present. As used herein, the term “and/or” includes any and all combinations of one or more of the associated listed items.

A membrane electrode assembly (MEA), according to aspects of the present invention, includes a binder layer, including a sulfonated polysulfone-clay nanocomposite and a tackifier, disposed between an electrolyte membrane and a catalytic layer. The tackifier facilitates the transfer of the catalytic layer to the surface of the electrolyte membrane and provides for a strong adhesion between the catalyst particles and the electrolyte membrane, while maintaining the porosity of the catalytic layer. As such, the strong adhesion facilitates the influx of fuel to the catalytic layer, as well as facilitates the removal of by-products. If there is no ion conductivity in the binder layer, the binder layer restricts the transport of ions. The composition described above improves the adhesion of catalyst layers to membranes, and can be used to produce a catalyst-coated membrane (CCM) having superior ion conductivity.

When the sulfonated polysulfone-clay nanocomposite is used, even when the polysulfone is highly sulfonated, the mechanical properties of the nanocomposite can be maintained.

The tackifier firmly adheres the binder layer to the electrolyte membrane. The tackifier may be an oligomer, or a polymer, having a low glass-transition temperature. The tackifier may include at least one selected from the group consisting of a polyethylene glycol, a polyethylene oxide, a polyethylene oxide copolymer, an acrylic-based tackifying polymer, and a polyurethane-ether copolymer. The mean molecular weight of the polyethylene glycol may be 50 to 500,000.

The content of the tackifier may be 3 to 250 parts by weight, based on 100 parts by weight of the sulfonated polysulfone-clay nanocomposite. If the content of the tackifier is less than 3 parts by weight, based on 100 parts by weight of the sulfonated polysulfone-clay nanocomposite, the bonding between the electrolyte membrane and the binding layer may have a low durability, due to the inflexibility of the binding layer. If the content of the tackifier is greater than 250 parts by weight, based on 100 parts by weight of the sulfonated polysulfone-clay nanocomposite, the ion conductivity of the CCM may be decreased.

The binder layer may further include a basic polymer. The basic polymer forms an ionic interaction with the sulfonated polysulfone, helping to control swelling of the tackifier. However, because a basic polymer does not have ion conductivity, using a large amount of the basic polymer decreases the ion conductivity, and thus, a small amount of the basic polymer is generally used.

The sulfonated polysulfone-clay nanocomposite is disclosed in Korean Patent Application No. 2005-89027 (which corresponds to U.S. Patent Publication No. 2007-72982), both of which are incorporated herein by reference. The nanocomposite has superior ion conductivity and includes a sulfonated polysulfone and a non-modified clay dispersed within the sulfonated polysulfone.

The non-modified clay refers to a layered silicate, wherein gaps between the layers thereof are expanded by water or an intercalant. The non-modified clay is formed using a simpler process, as compared to a modified clay formed with an organic phosphonium, an alkyl ammonium, or the like, thereby increasing manufacturing efficiency and reducing costs. In addition, the non-modified clay is more hydrophilic than methanol. When dispersed at a nanoscale size within the membrane, in an exfoliated form, or as an insert, only a small amount of the clay can suppress methanol cross-over. In addition, the absorptivity of the clay can also minimize the reduction of membrane conductivity, caused by the addition of an inorganic material.

The content of the clay may be 0.1 to 50 parts by weight, based on 100 parts by weight of the nanocomposite. If the content of the clay is less than 0.1 parts by weight, the barrier properties of the clay may not be realized. If the content of the clay is greater than 50 parts by weight, the viscosity of the nanocomposite becomes high, and the nanocomposite becomes brittle.

The non-modified clay may be a smectite clay. Examples of the smectite clay include montmorillonite, bentonite, saponite, beidellite, nontronite, hectorite, and stevensite.

The nanocomposite not only has the non-modified clay evenly dispersed within the sulfonated polysulfone, but the clay is present in exfoliated layers. In some cases, gaps between the layers may be increased. The sulfonated polysulfone can be intercalated within the layers.

The nanocomposite has good ion conductivity, mechanical strength, and heat resistance. When soaked with water, the intrusion of polar organic fuels, such as methanol, and ethanol, into the nanocomposite is suppressed. Therefore, the nanocomposite can minimize the crossover of polar organic fuels.

The sulfonated polysulfonate may be represented by Formula 1 below.

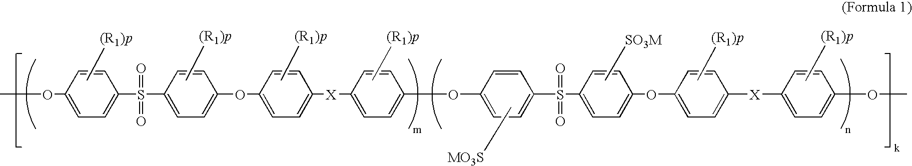

In Formula 1: each R₁ is independently selected from a C1-C10 alkyl group, a C2-C10 alkenyl group, a phenyl group, or a nitro group; p is an integer in the range of 0 to 4; X is —C(CF₃)₂—, —C(CH₃)₂— or —P(═O)Y′—(Y′ is —H or —C₆H₅); M is Na, K, or H; m is 0.1 through 0.9; n is 0.1 through 0.9; and k is an integer in the range of 5 to 500. In Formula 1, m and n each refer to a mixing ratio of the associated repeating unit, and the sum of m and n is 1.

R₁ may be a propyl group, p may be 0 or 1, X may be —C(CF₃)₂— or —C(CH₃)₂—, M may be Na, m may be 0.1 through 0.9, n may be 0.1 through 0.9, k may be 50, or more. According to some embodiments, m can be 0.2-0.5, or 0.4, n can be 0.5-0.8 or 0.6, and k can be an integer ranging from 100 to 300.

In Formula 1, the ratio of m to n represents a mixing ratio of the repeating units of a sulfonated sulfone without an SO₃M group and a sulfonated sulfone with an SO₃M group. Depending on the mixing ratio, the properties of the sulfonated polysulfone, such as ion conductivity, vary significantly. In some embodiments, m may be 0.2 to 0.5, and n may be 0.5 to 0.8, in order to achieve high ion conductivity.

The degree of sulfonation of the sulfonated polysulfone may be 20 to 80%, and in particular, may be 60%. If the degree of sulfonation is outside the above range, ion conductivity of the MEA may not be optimal. The group represented by (R₁)p is hydrogen when p is 0.

The sulfonated polysulfonate may be represented by Formula 2 below:

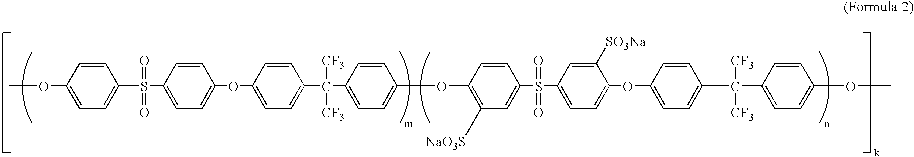

In Formula 2, m is 0.1 through 0.9, n is 0.1 through 0.9; and k is an integer in the range of 5 to 500. In some embodiments m may be 0.2-0.5, and in particular may be 0.4, and n may be 0.5-0.8, and in particular may be 0.6.

The sulfonated polysulfone of Formula 1 can be end-capped with a compound selected from the group consisting of an amino group that forms a strong affinity with the clay, by a cation exchange reaction with Na, K, etc., and a functional group such as a benzyl, a methyl, a sulfate, a carbonyl, or an amide group, which may form Van der Waals, polar, or ionic interactions with the clay. The end-capping compound has a strong interaction with the clay.

A clay reformer can be included with the clay. The clay reformer is a compound that forms a strong affinity with the clay, by a cation exchange reaction with Na, K, or the like, and a functional group such as a benzyl, a methyl, a sulfate, a carbonyl, or an amide group, which may form Van der Waals, polar, or ionic interactions with the clay. Examples of the clay reformer include 2-acetamidophenol, 3-acetamidophenol, 2,6-di-tert-butyl-4-methylphenol, 3-ethylphenol, 2-amino-4-chlorophenol, 6-amino-2,4-dichloro-3-methylphenol, 4-amino-3-methylphenol, 2-amino-3-nitrophenol, 2-aminophenol, 2-sec-butylphenol, 3-aminophenol, 3-diethylaminophenol, 4,4-sulfonyldiphenol, 2-methyl-3-nitrophenyl, 3-tert-butylphenol, 2,3-dimethoxyphenol, 4-amino-2,5-dimethylphenol, 2,6-dimethyl-4-nitrophenol, 4-sec-butylphenol, 4-isopropylphenol, 2-amino-4-tert-butylphenol, 2-tert-butyl-4-methylphenol, 4-tert-butyl-2-methylphenol, 4-tert-butylphenol, 2,6-di-tert-butyl-4-methylphenol, 2-amino-5-nitrophenol, 5-isopropyl-3-methylphenol, 4-(methylamino)phenol sulfate, 4-sec-butylphenol, 3-methoxyphenol, 3,5-dimethylthiophenol, 3,5-dimethylphenol, 2-aminophenol, 3-aminophenol, 4-aminophenol, 3-(N,N′-dimethylamino)-phenol, 2,6-dimethoxyphenol, 4-acetaminophenol, 2-amino-4-methylphenol, 2,5-dimethylphenol, 2-ethylphenol, 4-ethylphenol, and combinations thereof. The thickness of the binder layer of the present invention may be 5 to 100 μm.

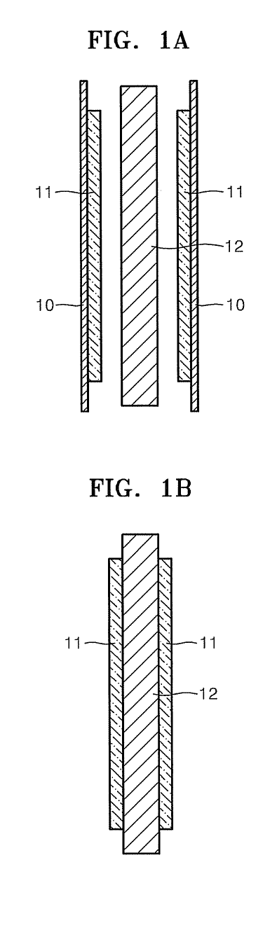

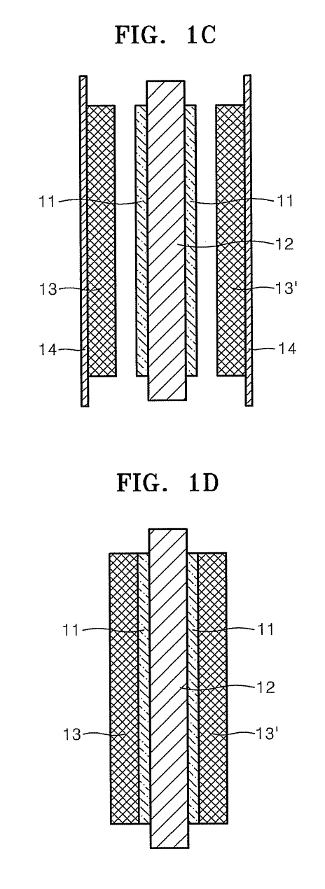

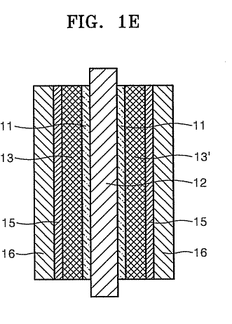

FIGS. 1A through 1D illustrate a method of forming an MEA, according to an exemplary embodiment of the present invention. In the method, a binder layer-forming composition is prepared by mixing a sulfonated polysulfone-clay nanocomposite, a tackifier, and a first solvent. The content of the tackifier may be 3 to 250 parts by weight, based on 100 parts by weight of the sulfonated polysulfone-clay nanocomposite. The first solvent may include at least one selected from the group consisting of N-methylpyrrolidinone, dimethylacetamide, and dimethylsulfoxide. The content of the first solvent may be 500 parts by weight, or less, and in particular may be 0.01 to 500 parts by weight, based on 100 parts by weight of the sulfonated polysulfone-clay nanocomposite. By adding the tackifier, a binder layer-forming composition forms a high-viscosity paste (viscosity of 10000 cps, or higher).

The binder layer-forming composition may further include a basic polymer. The basic polymer may include at least one selected from the group consisting of polybenzimidazole, poly(4-vinylpyridine), polyethylene imine, poly(acrylamide-co-diallyldimethylammonium chloride), poly(diallyldimethylammonium chloride), polyacrylamides, polyurethanes, polyamides, polyimines, polyureas, polybenzoxazoles, polybenzimidazoles, and polypyrrolidones.

The content of the basic polymer may be 0.01 to 20 parts by weight, based on 100 parts by weight of the sulfonated polysulfone-clay nanocomposite. If the content of the basic polymer is greater than 20 parts by weight, the ion conductivity of electrodes may be decreased. If the content of the basic polymer is less than 0.01 parts by weight, the basic polymer may not render the desired effects.

A first transfer film is formed by coating and drying the binder layer-forming composition on a first support membrane 10, to form a binder layer 11. The method of coating is not particularly limited, for example, a doctor blade method, bar coating, spin coating, and screen printing may be used. The use of a doctor blade method is described herein. Examples of the first support membrane 10 may include a polyethylene film (PE membrane), a mylar membrane, a polyethyleneterephthalate (PET) membrane, a TEFLON membrane, a polyimide membrane (KEPTON film), and a polytetrafluoroethylene membrane.

The drying may be performed at a temperature of 50 to 160° C., until at least 70% of the solvent is removed. When the solvent is removed, the contamination of the electrolyte membrane upon adhesion of the electrolyte membrane and the binder layer, or a decrease in the adhesive strength between the two layers, may be prevented.

A protective film (not shown) can be used to cover the binder layer 11. The transfer film is cut to size and the protective film is removed, before the transfer film is applied. A releasing polyethyleneterephthalate membrane may be used as the protective film.

Referring to FIG. 1A, the binder layer 11 of the first transfer film is disposed adjacent to an electrolyte membrane 12. Then, referring to FIG. 1B, the binder layer 11 is applied to the surface of the electrolyte membrane 12. The first support membrane 10 is then detached from the binder layer 11. According to other embodiments, the binder layer may be adhered to a surface of a catalytic layer, of an electrode catalytic layer transfer film, and then the resulting product can be adhered to the electrolyte membrane 12, as shown in Example 3.

The transfer of the binder layer 11 is performed for 20 minutes, under a pressure of 0.001 to 0.3 ton/cm², for example, a pressure of approximately 0.1 ton/cm², at room temperature (20-25° C.). In the alternative, a calendering method, or a method of adhering by passing through a rubber roller under a pressure of 0.05 ton/cm², at room temperature, may be used.

Referring to FIG. 1C, a second support membranes 14 having catalytic layers 13 and 13 appled thereto, are prepared. Here, the catalytic layers 13 and 13 may be formed by coating and drying a catalytic layer-forming composition onto the second support membranes 14. The catalytic layer-forming composition can comprise a metal catalyst, an ionomer, and a second solvent.

For the metal catalyst, Pt or a Pt alloy, such as PtRu, which are conventionally used in fuel cells, may be used. In the alternative, a support catalyst, in which the metal catalyst is supported by a separate support, may be used. Examples of the support may include a carbon powder, an activated carbon powder, a graphite powder, and a carbon molecular sieve powder. Specific examples of the activated carbon powder include VULCAN XC-72 and ketzen black. According to one example of the present invention, Pt is used as the metal catalyst for the cathode, and the PtRu alloy is used as the metal catalyst for the anode.

Examples of the second solvent may include water, ethylene glycol (EG), isopropyl alcohol, and polyalcohol. The content of the second solvent may be 250 to 300 parts by weight, based on 100 parts by weight of the metal catalyst.

A representative example of the ionomer may be a sulfonated, highly-fluorinated polymer e.g., NAFION (Dupont Co.), with a main chain composed of a fluorinated alkylene, and a sidechain composed of a fluorinated vinyl ether with sulfonic acid end groups, or any polymer having similar properties may be used. The ionomer is dispersed in the solvent, and the content of the ionomer may be 7.5 to 12.5 parts by weight, based on 100 parts by weight of the metal catalyst.

Referring again to FIG. 1C, the catalytic layers 13 and 13 are disposed adjacent to the binder layers 11 formed on the electrolyte membrane 12 and transferred thereto. The transfer can be performed for 1 to 30 minutes, under a pressure of 0.001 to 0.3 ton/cm², and at a temperature of 100 to 160° C.

Using the process described above, a CCM with the binder layers 11, and the electrode catalytic layers 13 and 13 formed on opposing sides of the electrolyte membrane 12, may be obtained, as shown in FIG. 1D. Then, as shown in FIG. 1E, a gas diffusion layer 15, and a backing layer 16 are hot pressed to each of the catalytic layers 13 and 13, to complete the formation of the MEA.

The process above describes a case in which the electrode catalytic layer is formed using a decal transfer method. However, the electrode catalytic layer can be formed by directly coating the catalytic layers on the binder layer. For example, after applying the binder layers 11 to the electrolyte membrane 12, catalytic layer-forming compositions are coated and dried directly on the gas diffusion layers 15, to form the electrode catalyst layers 13 and 13. Then, the electrode catalytic layers 13 and 13 are disposed on the binder layers 11 of the electrolyte membrane 12. The backing layers 16 are deposited on the catalytic layers 13 and 13, and the MEA is completed by hot-pressing the layers.

The hot-pressing may be performed at a temperature of 100 to 160° C., under a pressure of 0.001 to 0.3 ton/cm², for 1 to 20 minutes. For example, the hot pressing may be performed at a temperature of 100 to 160° C., at a pressure of 0.05 to 0.2 ton/cm², for 3 to 30 minutes, or at a temperature of 135° C., under the pressure of 0.1 ton/cm², for less than 20 minutes.

The electrolyte membrane 12 may be at least one selected from the group consisting of a perfluoro proton conductive polymer membrane (NAFION, Dupont Co.), a sulfonated polysulfone copolymer, a hydrocarbon polymer represented by sulfonated poly(ether-ketones), a perfluorinated sulfonic acid-containing polymer, sulfonated polyether ether-ketones, polyimides, polystyrenes, polysulfones, and a sulfonated polysulfone-clay nanocomposite. In particular, the membrane 12 is a sulfonated polysulfone-clay nanocomposite, due to the high adhesiveness (affinity) between the electrolytic membrane 12 and the binding layers 11.

Although the method of manufacturing the MEA of the present invention comprises first adhering the binder layers 11 to the surface of the electrolyte membrane 12, the binder layers 12 may be adhered to the electrode catalytic layers 13 and 13, and then adhered to the electrolyte membrane 12.

Hereinafter, the present invention is described with reference to the following examples. However, these examples are for illustrative purposes only and are not intended to limit the scope of the invention.

### SYNTHESIS EXAMPLE 1

### Preparation of Clay-Polysulfone of Formula 2 Nanocomposite

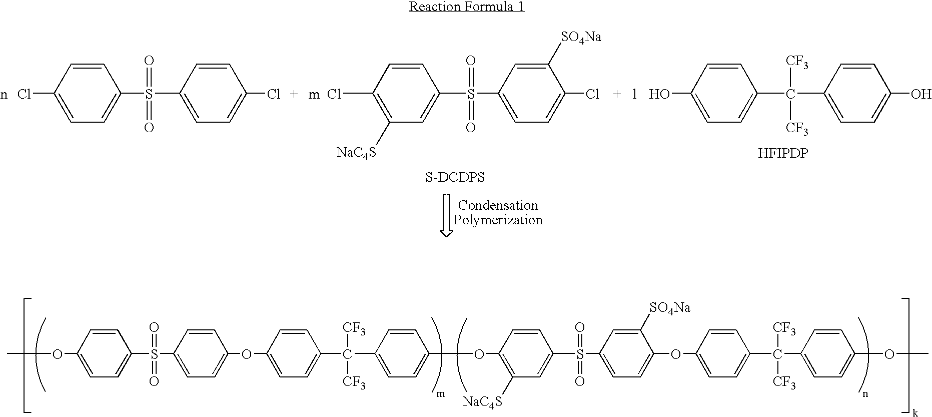

In Reaction Formula 1, m is 0.4, n is 0.6, and k is 120.

A mixture of sulfated-4,4′ dichlorodiphenyl sulfone (S-DCDPS, 0.1 mol), 4,4′dichlorodiphenyl sulfone (DCDPS, 0.35 mol), 4,4′-(hexafluoroisopropylidene)diphenol (HFIPDP, 0.459 mol), montmorillonitrile (3 parts by weight based on 100 parts by weight of monomer) as a nonmodified clay, and potassium carbonate (0.55 mol), were refluxed for 12 hours, at 160° C., using NMP (120 mL) and toluene (100 mL) as solvents, to remove water. After confirming that water was no longer coming out through a Dean Stock, toluene was removed through a valve. Sequentially, the reaction mixture was heated to 180° C., over 2 hours, and polymerization was carried out for 4 hours.

As polymerization progressed, the viscosity of the solution increased. Once the polymerization was complete, the polymerized product was cooled to room temperature; 000 mL of triple-distilled water was added thereto to be precipitated, and then the product was washed 3 times and then dried, to form a nanocomposite. The sulfonation degree of the nanocomposite was about 60%.

### EXAMPLE 1

A binder layer-forming composition was obtained by mixing 50 g of the sulfonated polysulfone-clay nanocomposite obtained according to Synthesis Example 1 (mean molecular weight: 90,000), 2.5 g of polybenzimidazole, which is a basic polymer, 15 g of polyethylene glycol (mean molecular weight: 3000), which is a tackifier, 5 g of N,N′-dimethylacetamide (DMAc), and 50 g of N-methyl-2-pyrrolidinone (NMP) which are solvents.

The binder layer-forming composition was coated on a PET membrane, which is a support membrane, and dried at a temperature of 100° C., using a hot-air drier for 30 minutes, to form a binder layer, thereby obtaining a binder layer-forming transfer film. The binder layer of the transfer film (thickness: 10 μm) was disposed adjacent to the sulfonated polysulfone-clay nanocomposite electrolyte membrane (mean molecular weight: 90,000, sulfonation degree: 60%), and the layers were adhered at room temperature (20˜25° C.) under 0.1 ton/cm², for 20 minutes. Then the PET membrane was removed from the resulting structure, by exfoliation.

Separately, a cathode catalytic layer was formed on a PET membrane, to prepare a cathode catalytic layer transfer film. Also, an anode catalytic layer was formed on a PET membrane, to prepare an anode catalytic layer transfer film. These transfer films were obtained according to the following process.

2 g of Pt-black was added to 20 mL reactor. To this, 1.25 g of a 20 wt % NAFION solution and 3 g of ethylene glycol (EG) were added and mixed in a high-speed vortex mixer (THINKY) for 3 minutes, to prepare a cathode catalytic layer-forming slurry. The mixing was performed 3 times to make the slurry homogeneous.

Then, 2 g of PtRu-black, 1.25 g of Nafion solution, and 3 g of EG were added to 20 mL reactor and mixed in a THINKY for 3 minutes, to prepare an anode layer-forming slurry. The mixing was performed 3 times to make the slurry homogeneous.

A polytetrafluoroethylene (PTFE) film, which is a support membrane for the transfer film, was disposed on top of a flat glass substrate, and a predetermined region of the PTFE film was covered with a polyethylene film (thickness: 110 μm), which is a mask for cathode catalytic layer patterning. The cathode catalytic layer-forming slurry was poured on the resulting product twice. By moving a bar-coater slowly, a homogenous cathode catalytic layer was prepared on the support membrane. The resulting product was dried at 120° C. in a vacuum oven, for 24 hours, to produce a cathode catalytic layer transfer film.

A PTFE film, which is a support membrane for the transfer film, was disposed on top of a flat glass substrate, and a predetermined region of the PTFE film was covered with a polyethylene film (thickness: 110 μm), which is a mask for anode catalytic layer patterning. The anode catalytic layer-forming slurry was poured on the resulting product twice. By moving a bar-coater slowly, a homogenous anode catalytic layer was prepared on the support membrane. The resulting product was dried at 120° C. in a vacuum oven, for 24 hours, to produce an anode catalytic layer transfer film.

The anode catalytic layer transfer film and the cathode catalytic layer transfer film were disposed on opposing sides of the sulfonated polysulfone-clay nanocomposite electrolyte membrane, including the binder layer. The anode catalytic layer and the cathode catalytic layer were each transferred to the membrane, at a temperature of 135° C. and a pressure of 0.1 ton/cm², for 20 minutes. Then the support membranes were removed to obtain the CCM. The CCM obtained using such method had a cathode with Pt-black loading of 4.8 mg/cm², and an anode with PtRu-black loading of 4.3 mg/cm².

A cathode gas diffusion layer and a backing layer were attached to a first side of the CCM, and an anode gas diffusion layer and a backing layer were attached to a second side of the CCM, and then hot-pressed to complete the manufacture of the MEA. The MEA supplied 1M methanol to an anode and supplied air to a cathode, and a fuel cell including the MEA was operated at a temperature of 60° C.

### EXAMPLE 2

A binder layer-forming composition was obtained by mixing 50 g of the sulfonated polysulfone-clay nanocomposite obtained according to Synthesis Example 1 (mean molecular weight: 90,000), 15 g of polyethylene glycol (mean molecular weight: 3000) which is a tackifier, 3 g of DMAc, and 30 g of NMP. The binder layer-forming composition was coated on a PET membrane and dried at 100° C., using a hot-air drier for 30 minutes, to form a binder layer, thereby obtaining a binder layer-forming transfer film.

The binder layer of the transfer film (thickness: 10 μm) was disposed adjacent to the sulfonated polysulfone-clay nanocomposite electrolyte membrane (mean molecular weight: 90,000, sulfonation degree: 60%), and the layers were adhered at room temperature (20˜25° C.) under 0.1 ton/cm² of pressure, for 20 minutes. Then the PET membrane was removed from the resultant structure by exfoliation.

The cathode catalytic layer-forming slurry obtained as described in Example 1 was poured twice on a gas diffusion layer, and a bar-coater was moved slowly to produce a homogeneous cathode catalytic layer on the electrolyte membrane. The resulting product was dried at a temperature of 120° C. in a vacuum oven, for 24 hours, to produce a cathode catalytic layer transfer film on top of the binder layer.

Next, the anode layer-forming slurry obtained as described in Example 1 was coated and dried on another gas diffusion layer, in the same manner as for the cathode layer, to form an anode catalytic layer. Then, the cathode catalytic layer and the anode catalytic layer, each formed on the gas diffusion layers, were placed on the binder layers of the electrolyte membrane obtained as described in Example 1.

A backing layer was deposited on a first side of the gas diffusion layer, on which the catalytic layer was not formed, and hot-pressed, to complete the manufacture of an MEA. The MEA supplied 1M methanol to an anode and supplied air to a cathode, and a fuel cell including the MEA was operated at a temperature of 60° C.

### EXAMPLE 3

The binder layer, of the binder layer-forming transfer film obtained according to the method described in Example 1, was placed in contact with the cathode catalytic layer surface of the transfer film, and the anode catalytic layer surface of the transfer film, according to the method described in Example 1, adhering the binder layer on top of the electrode catalytic layer first. Then, the resulting product was adhered to the sulfonated polysulfone-clay nanocomposite electrolyte membrane of Example 1, to form an MEA.

### EXAMPLE 4

The binder layer, of the binder layer-forming transfer film obtained according to the method described in Example 2, was placed in contact with a surface of the cathode catalytic layer and a surface of the anode catalytic layer, each formed according to the method described in Example 2, and the binder layer was adhered on top of the electrode catalytic layer first. Then, the resulting product was adhered to the sulfonated polysulfone-clay nanocomposite electrolyte membrane of Example 1, to form an MEA.

### EXAMPLE 5

An MEA was manufactured using the same method as described in Example 1, except that the basic polymer polybenzimidazole was not added when preparing the binder layer-forming composition.

### COMPARATIVE EXAMPLE 1

A cathode catalytic layer transfer film and an anode catalytic layer transfer film were obtained according to the method described in Example 1. The cathode catalytic layer transfer film and the anode catalytic layer transfer film were disposed on both sides of the nanocomposite electrolyte membrane obtained according to Synthesis Example 1, and the anode catalytic layer and the cathode catalytic layer were transferred to the membrane at a temperature of 125° C. and at a pressure of 0.5 ton/cm², for 8 minutes. Then the support membranes were removed from the anode catalytic layer and the cathode catalytic layer, to obtain a CCM.

A cathode gas diffusion layer and a backing layer were deposited on a side of the CCM, and an anode gas diffusion layer and a backing layer were attached to the other side of the CCM, and were then hot-pressed, to complete the manufacture of the MEA.

### COMPARATIVE EXAMPLE 2

An MEA was manufactured using the same method as described in Comparative Example 1, except that a NAFION 115 electrolyte membrane was used instead of the polysulfone nanocomposite electrolyte membrane of Formula 2.

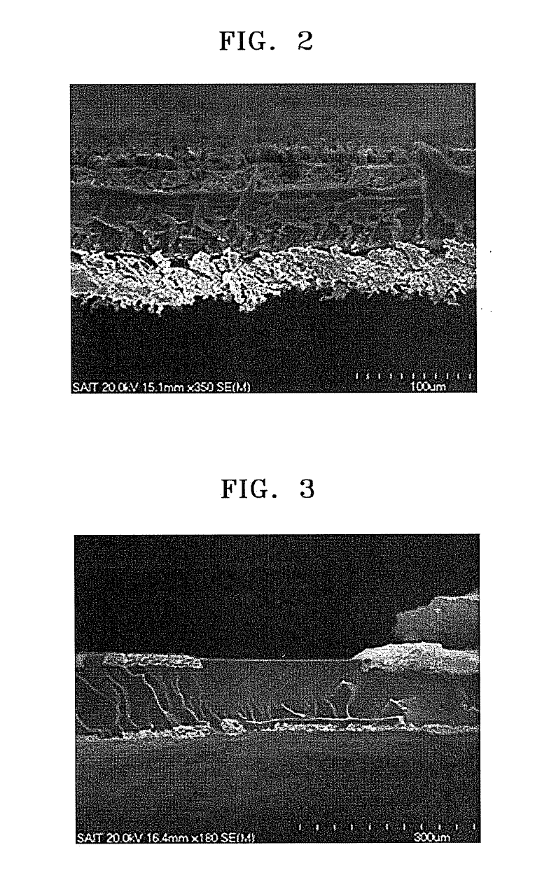

Scanning electron micrographs (SEM) of the anode CCMs manufactured according to Examples 1 to 5 and Comparative Example 1 were taken. FIGS. 2 and 3 are SEMs of the anode CCMs of Example 1 and Comparative Example 1, respectively.

Referring to FIG. 2, the CCM of Example 1 showed that the catalyst was transferred homogeneously to the electrolyte membrane under a low transfer pressure (0.1 ton/cm²) Examples 2 to 5 produced similar results. In contrast, referring to FIG. 3, catalyst detachment was observed, even though the CCM of Comparative Example 1 was transferred under a high pressure (0.5 ton/cm²).

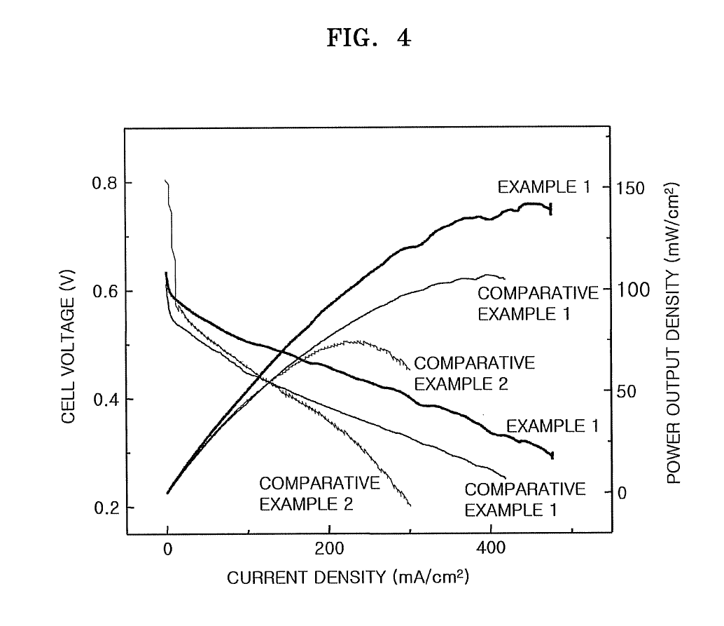

Moreover, in the fuel cells using the MEAs prepared according to Examples 1 to 5 and Comparative Examples 1 to 2, cell voltages and power densities with respect to current density were measured, and the results are shown in the graph of FIG. 4. Referring to FIG. 4, it can be seen that the fuel cell of Example 1 had improved cell voltage characteristics, as compared to Comparative Examples 1 and 2. In addition, the power output density of the fuel cell of Example 1 was enhanced, as compared to Comparative Examples 1 and 2. Upon further evaluation, Examples 2 to 5 also showed similar results as Example 1, with regards to power output densities.

The MEA, according to aspects of the present invention, provides a binder layer, including a sulfonated polysulfone-clay nanocomposite and a tackifier, between the electrolyte membrane and the electrode catalytic layer, allowing a low surface resistance between the electrolyte membrane and the electrode catalytic layer, and an optimal catalytic layer porosity, thereby enabling the manufacture of a fuel cell with improved performance. The fuel cell, according to aspects of the present invention, may be a direct methanol fuel cell.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A membrane electrode assembly (MEA), comprising:
an electrolyte membrane;
binder layers comprising a sulfonated polysulfone-clay nanocomposite and a tackifier, disposed on opposing sides of the electrolyte membrane; and
electrodes comprising catalytic layers, disposed on the binder layers.

2. The MEA of claim 1, wherein the sulfonated polysulfone-clay nanocomposite comprises:
layers of a non-modified clay; and
a sulfonated polysulfone disposed between the layers.

3. The MEA of claim 2, wherein the sulfonated polysulfone is represented by Formula 1 below: 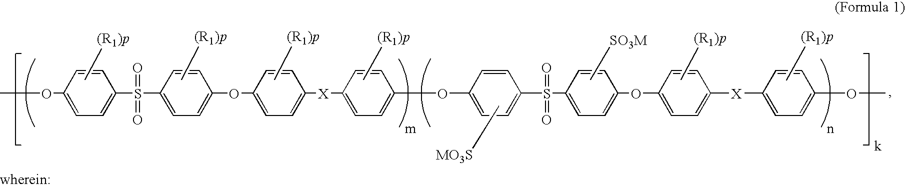
each R₁ is independently selected from the group consisting of a C1-C10 alkyl group, a C2-C10 alkenyl group, a phenyl group, and a nitro group;
p is an integer from 0 to 4;
X is —C(CF₃)₂—, —C(CH₃)₂—, or —P(═O)Y′—(Y′ is —H or —C₆H₅);
M is Na, K, or H;
m is from 0.1 to 0.9;
n is from 0.1 to 0.9; and
k is an integer from 5 to 500.

4. The MEA of claim 2, wherein the sulfonated polysulfone is represented by Formula 2 below: 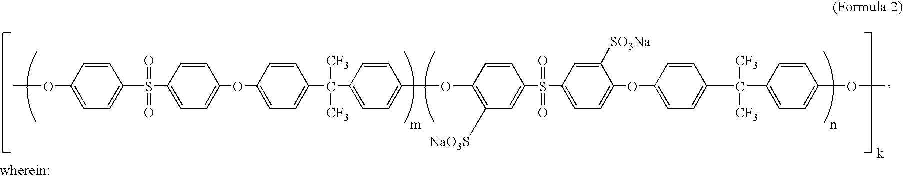
m is from 0.1 to 0.9;
n is from 0.1 to 0.9; and
k is an integer from 5 to 500.

5. The MEA of claim 1, wherein the tackifier comprises at least one selected from the group consisting of a polyethylene glycol, a polyethylene oxide, a polyethylene oxide copolymer, a polybutyl acrylate copolymer, and a polyurethane-ether copolymer.

6. The MEA of claim 1, wherein the binder layer further comprises a basic polymer.

7. The MEA of claim 6, wherein the basic polymer comprises at least one selected from the group consisting of a poly(4-vinylpyridine), a polyethylene imine, a poly(acrylamide-co-diallyldimethylammonium chloride), a poly(diallyldimethylammonium chloride), a polyacrylamide, a polyurethane, a polyamide, a polyimine, a polyurea, a polybenzoxazole, a polybenzimidazole, and a polypyrrolidone.

8. The MEA of claim 6, wherein the content of the basic polymer is 0.01 to 20 parts by weight, based on 100 parts by weight of sulfonated polysulfone-clay nanocomposite.

9. The MEA of claim 1, wherein the content of the tackifier is 3 to 250 parts by weight, based on 100 parts by weight of the sulfonated polysulfone-clay nanocomposite.

10. The MEA of claim 1, wherein the thickness of the binder layer is from 5 to 100 μm.

11. The MEA of claim 1, wherein the electrolyte membrane comprises at least one selected from the group consisting of a perfluorinated proton conductive polymer membrane, a sulfonated polysulfone copolymer, a sulfonated poly(ether-ketone), a perfluorinated sulfonic acid-containing polymer, a sulfonated polyether ether-ketone, a polyimide, a polystyrene, a polysulfone, and a sulfonated polysulfone-clay nanocomposite.

12. A method of manufacturing an MEA, comprising:
mixing a sulfonated polysulfone-clay nanocomposite, a tackifier, and a first solvent, to obtain a binder layer forming composition;
coating the binder layer-forming composition on a first support membrane and then removing the solvent, to form a binder layer on the first support membrane;
attaching the binder layer to a first surface of an electrolyte membrane and then removing the first support membrane from the binder layer;
applying a catalytic layer to a second support membrane; and
attaching the catalytic layer to the binder layer and then removing the second support membrane from the catalytic layer.

13. The method of claim 12, wherein the attaching of the catalytic layer comprises applying a transfer pressure of from 0.001 to 0.3 ton/cm².

14. The method of claim 12, further comprising, attaching an electrode gas diffusion layer and a backing layer to the catalytic layer, by hot-pressing.

15. The method of claim 12, wherein the binder layer-forming composition further comprises a basic polymer.

16. A method of manufacturing an MEA, comprising:
mixing sulfonated polysulfone-clay nanocomposite, a tackifier, and a first solvent, to obtain a binder layer-forming composition;
coating binder layer-forming composition on a first support membrane and then removing the solvent, to form a binder layer on the first support membrane;
attaching the binder layer to the electrolyte membrane and then removing the first support membrane from the binder layer;
coating a catalytic layer-forming composition comprising a metal catalyst, an ionomer, and a second solvent on a gas diffusion layer, to form an electrode catalytic layer; and
attaching the electrode catalytic layer to the binder layer.

17. The method of claim 16, further comprising, hot pressing a backing layer to the gas diffusion layer.

18. The method of claim 16, wherein the binder layer-forming composition further comprises a basic polymer.
